(19) United States
(12) Patent Application Publication
(10) Pub. No.: US 2021/0152781 A1
(43) Pub. Date: May 20, 2021

(54) OBJECT DETECTION

(71) Applicant: SIGNIFY HOLDING B.V., EINDHOVEN (NL)

(72) Inventors: RALF GERTRUDA HUBERTUS VONCKEN, EINDHOVEN (NL); ALEXANDRE GEORGIEVICH SINITSYN, VELDHOVEN (NL); JUDITH HENDRIKA MARIA DE VRIES, BUDEL-SCHOOT (NL); DOMINIKA LEKSE, BUDEL-SCHOOT (NL); TOM VERHOEVEN, EINDHOVEN (NL)

(21) Appl. No.: 16/492,149

(22) PCT Filed: Mar. 1, 2018
(86) PCT No.: PCT/EP2018/055031

§ 371 Date: Sep. 8, 2019

(30) Foreign Application Priority Data
Mar. 10, 2017 (EP) 17160232.9

(51) Int. Cl. H04N 7/18; H04N 5/225; G06K 9/00

(52) U.S. Cl. CPC H04N 7/181; G06K 9/00785; H04N 5/2256

(57) ABSTRACT

A global object detection system comprising a plurality of local object detection systems, each arranged to monitor a respective area and comprising: an image capture device arranged to capture image data from its respective area; an illumination device for emitting light into its respective area; a local object detector for detecting objects in that area; a data interface for transmitting data from the local object detector to a central, remote image processing system; wherein the local object detector is configured to: control the illumination source to emit light having an identifiable characteristic; apply local image processing to the captured image data to detect objects in that area, as an absence of the identifiable characteristic in a shadow region created by the object; in response to an object being detected, transmit a portion of the image data including the detected object to the remote image processing system for further processing.

### TECHNICAL FIELD

The present disclosure relates to the detection of objects based on shadow detection, and particularly static objects.

### BACKGROUND

Object detection is an important problem, particularly in the context of road safety. Stray objects on roads such as debris, dropped cargo or animal corpses, can cause serious traffic accidents. However, distinguishing potentially dangerous stray objects from their surroundings in an automated fashion is not straightforward. Even objects that a human can distinguish easily can be much harder for a computer to detect, using so-called machine vision techniques.

### SUMMARY

Governments invest heavily in traffic management systems, which often make use of cameras. The camera images are streamed to a surveillance room where all the video images are analysed manually. In some cases, the system is equipped with smart algorithms that are capable of automatically detecting dangerous traffic situations by analysing the camera images (e.g. to identify changes over time). However, these algorithms are unreliable for detecting static objects on the road that can lead to dangerous traffic situation. For example, after a tire blowout a large piece of tire is left on the road, cargo that fell of a truck, objects that were thrown out or fell of vehicles, objects blown on the road, dead animal, etc.

The present invention uses shadow detection to detect objects. An area is illuminated by light having an identifiable characteristic(s), e.g. a particular wavelength or set of wavelengths, modulation frequency etc., and any objects in that area are detected from shadow regions they create, in which that characteristic is absent, using image processing. The object may for example be detected based on known image processing techniques, which can take into account a shadow once such shadown has been identified. Image processing techniques may further be applied to an area proximate to the detected shadow created by the object, to limit the amount of processing required (i.e. to avoid having to perform such image analysis for the full image, not withstanding that some image analysis is performed to detect the shadow). As another example, knowing an estimated, measured or assumed light angle incidence, the object causing the detected shadow may be determined based on spatial characteristics of the determined shadow.

One way of implementing this would be to transmit a stream of image data continuously to a remote (back-end) image processing system. However, this would require a significant amount of data to be transmitted to the back-end system constantly, particularly when a large number of areas are monitored. It would also require significant processing resources at the back-end as shadow-based object detection can be resource-heavy as it requires the use of image processing algorithms which is typically processor-intensive. On the other hand, it would be highly undesirable to sacrifice reliability of object detection, as this can lead to hazardous situations such as objects on a highway going unreported, with potentially lethal consequences.

It would therefore be desirable to reduce processing load and the amount of image data that needs to be sent to the back-end system within a shadow-based object detection system without compromising on object detection reliability and also to reduce the processing burden on the back-end.

Hence, according to a first aspect disclosed herein, there is provided a global object detection system comprising a plurality of local object detection systems, each arranged to monitor a respective area and comprising: at least one image capture device arranged to capture image data from its respective area; at least one illumination device for emitting light into its respective area; a local object detector connected to the image capture and illumination devices for detecting objects in that area; a data interface for transmitting data from the local object detector to a central, remote image processing system via a communication channel between the local object detector and the remote image processing system; wherein the local object detector is configured to: control the illumination source to emit light having an identifiable characteristic whilst the image data is captured; apply local image processing to the captured image data to detect objects when present in that area, a present object detected from an absence of the identifiable characteristic in a shadow region created by the object; in response to an object being detected, transmit a portion of the image data including the detected object via the communication channel to the remote image processing system for further processing.

In embodiments, the portion of image data is transmitted to the remote image processing system in response to the local object detector determining that the detected object meets a set of one or more object criteria.

In embodiments, the local object detector is further configured to determine an estimated size of the object based on a size of the shadow region, and wherein said transmission of the portion of the image data is performed in response to determining that the estimated size is larger than a threshold size.

In embodiments, the local object detector is further configured to determine a reflection property of the object from the image data, and wherein said transmission of the portion of the image data is performed only if the reflection property corresponds to one of a predetermined set of materials.

In embodiments, the local object detector is further configured to determine an estimated location of the object based on a location of the shadow region. Optionally said transmission of the portion of the image data is performed in response to determining that the estimated location is within a predetermined sub-region of the area.

In embodiments, the portion of image data is transmitted to the remote image processing system in response to the local object detector determining that area meets a set of one or more area criteria.

In embodiments, the local object detector is further configured to receive traffic information indicating an amount of traffic within the area; and wherein said controlling the illumination source to emit light having an identifiable characteristic is performed in response to said amount of traffic exceeding a threshold amount of traffic.

In embodiments, the local object detector is further configured to determine a characteristic of ambient light within the area; and wherein said identifiable characteristic is chosen by the local object identified to be different from the determined characteristic of the ambient light.

In embodiments, the local object detector is further configured to control the illumination source to change a property of its emitted light in order to identify the illumination source to a user. Thus, a visible characteristic of the light emitted by the illumination source (i.e. a property of its emitted light) may be controlled (e.g. modified) such that a user may identify said illumination source. For example, the illumination source may change color or emit a dynamic light patter (e.g. flasing at a certain frequency) which allows a user to distinguish the emitted light by said light source from light emitted by other illumination sources and thereby also identify the illumination source. Continuing the example, a user may look up at an illumination source and notice that one is emitting red light whereas the other are emitting white light. Thus the illumincation source has been identified to the user.

In embodiments, the property of the emitted light is one or more of: a colour; and a flashing rate.

In embodiments, the property of the emitted light is an identifier code emitted as high-frequency modulations in the emitted light.

In embodiments, the local object detector is further configured to store properties of a first detected object to a memory; upon detection of a second detected object at a later point in time, to access the memory to determine whether or not the detected second object has the same properties as the properties of the first object stored in memory; and, if so, to include in a second transmission to the remote image processing system an indication that the second object matches the first object.

In embodiments, the portion of the image data includes at least one image on which shadow-based object detection can be performed to independently verify the presence of the object at the remote image processing system.

In embodiments, the local object detector is configured to transmit, along with the portion of image data, an indication that the detected object meets the set of one or more object criteria.

According to a second aspect disclosed herein, there is provided a local object detector for use in a local object detection system arranged to monitor a respective area, the local object detector comprising: at least one image capture device arranged to capture image data from its respective area; at least one illumination device for emitting light into its respective area; a local object detector connected to the image capture and illumination devices for detecting objects in that area; a data interface for transmitting data from the local object detector to a central, remote image processing system via a communication channel between the local object detector and the remote image processing system; wherein the local object detector is configured to: control the illumination source to emit light having an identifiable characteristic whilst the image data is captured; apply local image processing to the captured image data to detect objects when present in that area, a present object detected from an absence of the identifiable characteristic in a shadow region created by the object; in response to an object being detected, transmit a portion of the image data including the detected object via the communication channel to the remote image processing system for further processing.

According to a third aspect disclosed herein, there is provided a method of detecting objects in a global object detection system comprising a plurality of local object detection systems, the method comprising steps of: capturing image data from a respective area monitored by the local object detection system using at least one image capture device; control at least one illumination source to emit light into the area having an identifiable characteristic whilst the image data is captured; apply local image processing to the captured image data to detect objects when present in that area, a present object detected from an absence of the identifiable characteristic in a shadow region created by the object; in response to an object being detected, transmit a portion of the image data including the detected object via a communication channel to a remote image processing system for further processing.

According to a fourth aspect disclosed herein, there is provided a computer program product comprising computer-executable code embodied on a computer-readable storage medium configured, so as when executed by one or more processing units, to perform the steps according to the method of the third aspect.

### BRIEF DESCRIPTION OF THE DRAWINGS

To assist understanding of the present disclosure and to show how embodiments may be put into effect, reference is made by way of example to the accompanying drawings in which:

FIG. 1 shows a connected lighting system according to embodiments of the present invention;

FIG. 2 illustrates shadow-based object detection using one luminaire and one camera;

FIG. 3 shows a back-end system capable of receiving data from multiple lighting systems performing shadow-based object detection;

FIG. 4 is a schematic of a device in a lighting system; and

FIG. 5 illustrates shadow-based object detection using multiple luminaires and cameras.

### DETAILED DESCRIPTION OF EMBODIMENTS

Cities are becoming denser and consequently the amount of traffic (e.g. by various types of motorized and un-motorized vehicles) is increasing. This is a major contributing factor to the increase in road deaths to around 1.24 million registered road deaths annually worldwide. If nothing changes in the future, this number will only continue to grow. Therefore, it would be desirable to look into smart solutions to create smarter vehicles, e.g. self-driving cars. Note that a vehicle such as a car may be “smart” without being entirely autonomous. Smart vehicles of this kind may, for example, comprise various sensors for scanning the environment and alerting the driver to various hazards. Some smart vehicles may take action to avoid such hazards. Smart vehicles are becoming more prevalent, and create a safer road experience in travelling from point A to point B. These vehicles can make use of embedded sensors capable of scanning its surrounding, and the input from these sensors is crucial in warning or correcting the driver. In some cases the sensors may even enable a complete take over the control of the vehicle. However, smart vehicles do not yet provide a complete solution to road safety.

Governments and private businesses alike have recognized this issue and are investing heavily in creating safer roads. For example, 18 cities in the United States have embarked on “Vision Zero” programs to achieve zero roadway deaths. San Francisco alone has dedicated $120 million to their efforts.

City planners have taken bold measures to make cities safer by creating safe road environments. However, there will always be many unexpected and unpredictable factors affecting the road environment through extreme weather, natural disasters, bad intentions of people, etc.

The described embodiments of the present invention make use of a connected lighting infrastructure comprising a plurality of light poles (street lights) having a luminaire for illuminating an area and a camera for capturing images. Each pole is capable of sending and receiving information by making use of wireless (e.g. WiFi, 3G, LTE) or wired communication method, as known in the art.

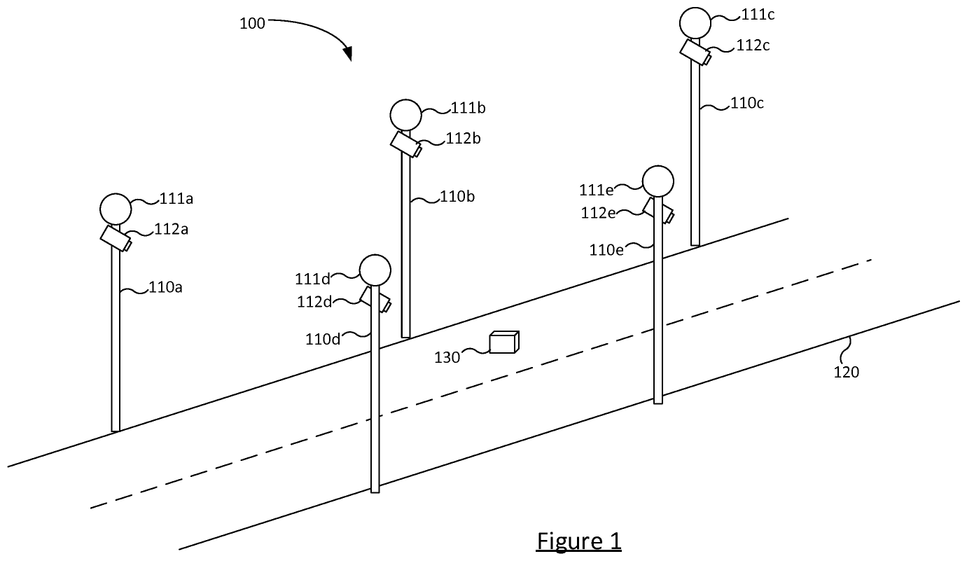

An example of this is shown in FIG. 1. The connected lighting system 100 comprises a plurality of light poles 110a-e which are street lights disposed along the length of a road 120 or other public way (e.g. a pavement). Each light pole 110a-e comprises a respective luminaire 111a-e and a respective camera 112a-e (or other sensor capable of detecting visual elements). Though not shown in FIG. 1, the luminaires 111 and cameras 112 of each light pole 110 form a data network as well known in the art by being provided with respective wired or wireless connections.

Note that, in general, every light pole 110 will comprise a respective luminaire 111, but it is not necessary for every light pole 110 to comprise a camera 112. That is, one or more of the light poles 110a-e may not comprise a camera 112. Similarly, one or more light poles 110 may comprise two or more cameras 112, arranged to face different directions and therefore to capture images from different sections of the road 120 (or surrounding area).

The combination of at least one luminaire 111 (comprising an illumination device) and at least one camera 112 (comprising an image capture device) is used to perform shadow-based object detection in order to detect objects such as object 130 shown in FIG. 1 on the road 120 (or within the general vicinity of the road 120) as described in more detail below.

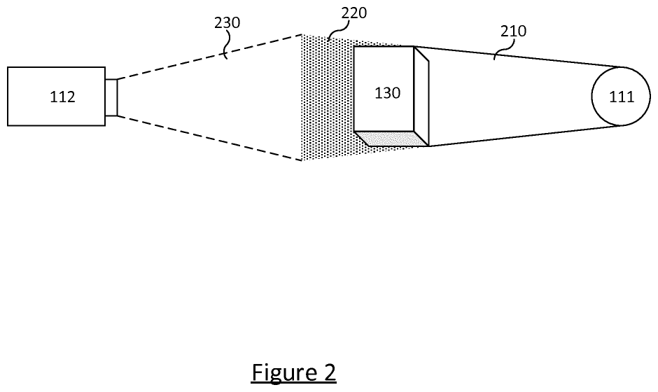

FIG. 2 illustrates a simple shadow-based object detection technique performed by one luminaire 111 (i.e. one of the luminaries 111a-e) and one camera 112 (i.e. one of the cameras 112a-e) in order to detect the object 130.

The luminaire 111 emits illumination 210 (i.e. a light output at a human-visible colour) which is cast within an area. The illumination 210 may be emitted by the luminaire 111 in all directions, or may be directed to a particular solid angle. In either case, the illumination 210 may or may not be constricted by housing of the luminaire 111 (e.g. shades and/or lenses). The luminaire 111 is there to illuminate the road 120, and so the luminaire 111 will be arranged (e.g. during installation) such that the illumination 210 falls on a section of the road 120 (possibly spilling into surrounding areas).

When an object 130 is present on the road 120, it creates a shadow 220 by blocking at least some of the illumination 210. If this shadow 220 falls within an image capture area 230 of the camera 112, the shadow 220 will appear in images captured by the camera 112.

When a plurality of luminaires 111a-e are present, and if other(s) of the luminaries 111b-e provide substantially the same illumination (e.g. same colour) as the first luminaire 111a, then this illumination may fall within the shadow area 220 created by the first luminaire 111a (as described above) and therefore the shadow 220 may not be detectable in images captured by the camera 112. To counter this, the luminaire 111a configured to send out a lighting pattern at a specific moment in time which differs from the lighting pattern emitted by the other luminaires 111b-e (e.g. a different colour). This creates a unique shadow pattern on the road 120 to support automatic detection of static objects. For example, luminaire 111a may output a red illumination 210, in which case the images captured by the camera 112 can be filtered to look for shadows which occur in the red-component of the images.

Once the object 130 is detected, one or more images of the object 130 can be transmitted to a remote, back-end system—which is a central image processing system—along with information about the detected object determined locally. The back-end image processing system is a computer system comprising one or more computer devices such as servers. It can apply further image processing to the received images, and if that processing confirms the presence of the objects it can, for example, alert a user in a traffic control room or other back office. Alternatively, the back-end system 300 can apply minimal processing to cause the image data to be displayed to a user(s) in the back office, possible with an alert. The user in the back office can operate a user device at which information from the back-end system 300 can be outputted.

In a preferred embodiment, the (video) images from the camera 112 are compared with video images observing the same area, captured at some previous time. A part of the image, with the static object will be highlighted and distinguished better in the new images due to the shadow 220 created by the object 130. In this way, a video processing algorithm performs more reliably. Once the static object 130 is detected, this system is able to send an alert to the end users, for example to traffic management department or to “connected cars” passing by.

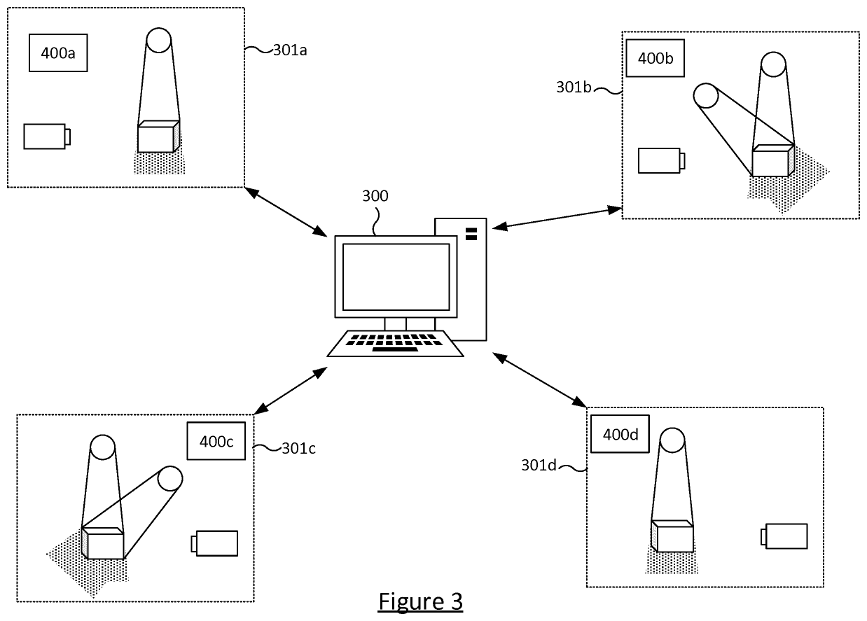

FIG. 3 shows such an arrangement. The back-end system 300 may be arranged to receive such alerts from multiple lighting systems 301a-d. Each lighting system 301a-d shown in FIG. 3 represents an individual implementation of shadow-based object detection with at least one camera 112 and one luminaire 111. That is, each lighting system 301a-d may be a separate system such as the system 100 shown in FIG. 1, or may represent a sub-group of part of the system 100 shown in FIG. 1. For example, lighting system 301a may comprise luminaire 111a and camera 112a, and lighting system 301b may comprise luminaires 111b and 111c and camera 111b from FIG. 1.

Each system 301a-d constitutes a local object detection system which monitors its respective area and comprises its own local object detector for detecting objects in that area using shadow detection. Collectively, they form a global object-detection system which can cover a potentially large region, such as a city or significant part of it at least. At least one of the local systems 301a-d maybe, say, 1 km or more away from the back-end image processing system 300.

In any case, each of the lighting systems (or sub-systems) 301a-d act independently to perform shadow-based object detection with a respective area and to transmit alert messages to the back-end system 300 upon detection of an object. It is appreciated that the four lighting systems 301a-d shown in FIG. 3 are only examples, and that more or fewer lighting systems may be present and reporting data to the back-end system 300. In any case, it is also appreciated that this can result in a large amount of data being received (especially when a large number of lighting systems are present). It would be desirable therefore to reduce the number of messages sent from each lighting system 301 to the back-end system 300, while still providing the back-end system 300 with desired alerts (e.g. high priority, or danger), and image data from the area.

Each of the systems 301a-d comprises a respective local detector (400a-d respectively) local to that system and in the vicinity of the camera(s) and luminaire(s) of that system e.g. within a 100 m radius of each (for example). Each of the local object detectors 400a-d performs shadow-based object detection local to its respective area (i.e. in that area only) independently of the other local object detectors. Each only sends image data to the remote image processing system 300 when it actually detects an object in that area.

The images from the camera system can be used for shadow detection at the remote system 300, to verify the presence of the object. When images are sent to the back-end system, they can be complemented by data related to the shadow detection, such as an indication that one or more object criteria for the shadow detection are met. There can be a threshold for the shadow detection at each local object detector (e.g. to only perform it for static objects). In this case, a potential static object can be detected, and shadow detection used in response to verify that it actually is an object in the area and not e.g. a shadow from an object outside the area, a road marking, or projection etc. The outcome of the shadow detection can relate to the size or position of the detected object on the road, but can also be based on contextual information such as time of day and such.

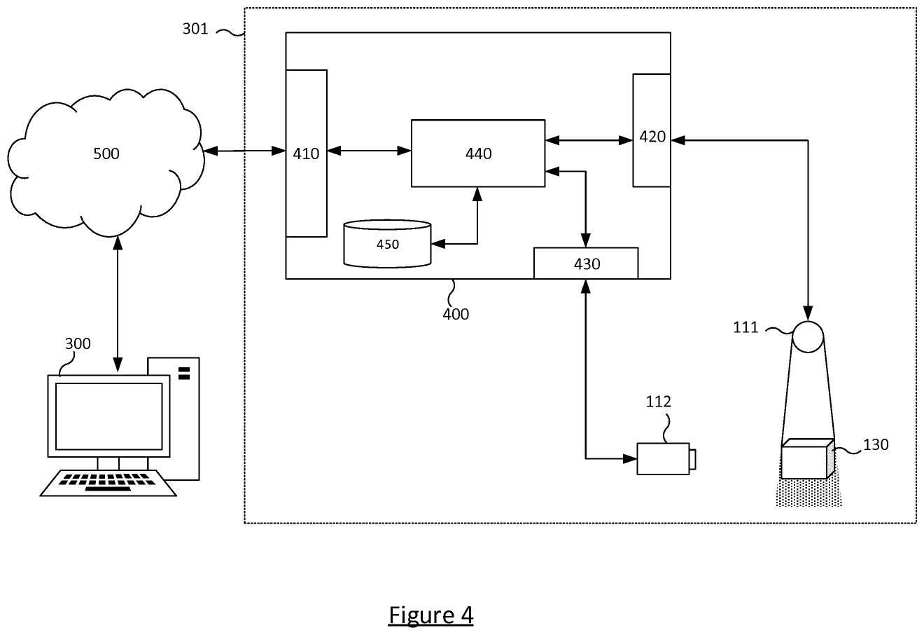

FIG. 4 shows a more detailed view of one of the lighting systems 301. All description of FIG. 4 applies individually to each of the local object detection systems. As mentioned above, the system 301 comprises at least one camera 112 arranged to capture images within an area and at least one luminaire 111 arranged to illuminate (at least) the area or part of the area.

A local object detector 400 is provided for the purposes of sending/receiving data to/from the camera 112 and (optionally, see below) luminaire 111 in order to perform shadow-based detection of objects such as object 130 shown in the figure. The local object detector 400 can be part of the luminaire, the camera, or a separate device as shown in the figure.

The local object detector 400 comprises a network interface 410, a lighting interface 420, a camera interface 430, a controller 440 and a memory 450. The controller 440 is operatively coupled to each of the network interface 410, the lighting interface 420, and the camera interface 430.

The lighting interface 420 comprises at least an output for sending control signals to the luminaire 111.

The camera interface 430 comprises at least an input for receiving data from the camera 112.

The memory 450 comprises one or more memory units such as solid-state or magnetic memories.

The network interface 410 is an interface for connecting to a network 500 such as the Internet, or a mesh network such as a ZigBee network.

The controller 440 comprises computer-executable code configured to run on one or more processing units such as CPUs. Alternatively, the controller 440 may also be implemented in purpose-built hardware. It is also not excluded that the controller 440 be implemented as a combination of hardware and software.

The controller 440 is configured to control the luminaire 111 to emit a unique light output (as described above) for the purposes of shadow-based object detection. E.g. the controller 440 may transmit one or more control commands to the luminaire 111 which the luminaire 111 receives and, in response thereto, changes at least one property of its provided illumination.

The controller 440 is configured to receive images captured by the camera 112 via the camera interface 430 and to process these images in accordance with shadow-based object detection techniques in order to determine the presence of an object 130. In response to determining that the object 130 is present, the controller 440 can generate a report of the detection (e.g. comprising the date and time, and location of the object etc.) or can do nothing. The controller 440 can store the generated report in memory 450 and/or transmit the report, using the network interface 410, via the network 500 to the back-end system 300. As mentioned above, this results in a reduced average amount of data transfer in the system as a whole over time. The object detection algorithm (e.g. self learning) performed by the controller 400 (or at the back end 300) can be (remotely) upgraded. This increases the object detection success rate and reduces the false-positive/positive-false object detection rate.

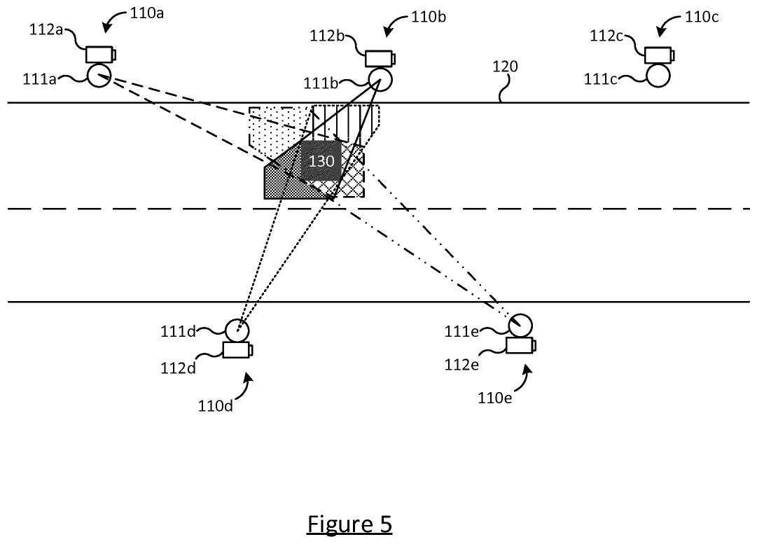

FIG. 5 illustrates an embodiment in which multiple poles 110a-3 are being used to detect a static object 130 on the road by sending out a unique lighting pattern per pole in a specific order in time. The processor 440 is may be capable of knowing when a certain light pole has emitted a lighting pattern as well as optionally knowing the exact location and light pattern emitted by each individual light pole. In these cases, this information can be used as input to detect a potential object from multiple angles in order to increase the reliability of the system.

In a simpler case, the controller 400 performs the method described above in relation to FIG. 2 for two or more camera-luminaire pairs and correlates the results. For example, using a first camera to detect both a first and second shadows created by respective first and second luminaires. Different cameras (i.e. a first and second in this example) may be used to detect the respective shadows. Each pair allows the identification of a respective “object detection instance” (i.e. a “potential object”)—a first and second in this case. If the instances correlate in time and/or space, the processor 440 can use this to infer that they likely relate to the same object. For example, if they occur within a predefined time period of each other (e.g. one minute), or within a predefined distance from one another (e.g. within ten metres). In the latter case, the distance can be approximated using the distance between the detecting cameras (or luminaires) themselves.

First one pole, e.g. pole 110a, sends out a light signal using its luminaire (luminaire 11a) and the other poles 110b-e will then turn down (or off) for a short period of time depending on the pattern and detected traffic on the road. Traffic can be detected through a variety of means in order to determine traffic level (e.g. a number of vehicles on the road) at a given time. For example, an existing traffic management system could be used, or an external source of traffic data (e.g. from a service provider tracking mobile phone locations). Alternatively, the cameras 112 themselves can be used (note that some may form part of the existing traffic management system) as they are arranged to capture images of the road which means that known object-recognition techniques can be applied to images captured by the cameras in order to determine traffic level. Note that traffic levels can be determined by non-camera sensors, such as ultrasonic or infrared sensors, as known in the art.

To prevent disturbance for the drivers, different patterns will be available, where some will be more aggressive (i.e. more noticeable to a human, e.g. flashing) and used when the road is empty, determined as above, and others will be subtler (i.e. less noticeable, if at all, to a human, e.g. high frequency modulations in the light) to avoid disturbance of the drivers. The cameras of the other poles 110b-e will capture video images and send a portion of these images to the back-end. Then the images are compared to a standard situation (no shadow); in case there is a difference (shadow is casted on the road) the system can decide to send an alert to a potential end-user or do an additional check.

It is appreciated that the above embodiments have been described by way of example only and are not intended to limit the scope of the claimed invention. There are a variety of extensions to the basic principle of the main embodiments, some non-limiting examples are given below.

In a possible embodiment, only one camera in this area will capture different shadows. That is, instead of all cameras 112 actively capturing images, only a single camera is active. The poles will be used to change the light pattern to check for a potential unwanted static object. Having only one camera be active will reduce running costs in the system, but might have a detrimental effect on the reliability of the system.

In a possible embodiment, the size and type of the unwanted object can be detected through analysing the size of the casted shadow on the road by making use of images from different angles or systems. The size of the object can be important for the end user to decide on the seriousness of the situation.

Estimating the size of the object 130 is a problem of computer vision, where a 3D model of the object 130 can be constructed based on angles and shadow projections on the road using knowledge of the location of the luminaires 111 and cameras 112. The 3D model can be approximated (e.g. as a simple geometric shape such as a cuboid, prism, or sphere) for simplicity. The constructed 3D model enables calculations of the volume of the object.

Estimating the type of the object 130 is a problem of data classification. Having upfront a number N of object classes for different volume ranges allows the classification to be performed by the processor 440 based on the volume of the object (determined as above). For example, there may be three classes: small objects (e.g. <125 cm³), medium objects (125 cm³ to 1000 cm³), big objects (>1000 cm³).

In a possible embodiment, an unwanted object detected by the system is highlighted using the connected lighting infrastructure. Light setting of lighting nodes in the area where an unwanted object is being detected can change (e.g. light intensity, colour of light, spot light, direction of lighting, interval of light flickering, etc.).

In a possible embodiment the natural light (e.g. sunlight or moonlight) is being used in combination with artificial light from the connected lighting system to detect potential unwanted objects in an area. Data about the behaviour of the natural lighting will be collected via an external source. The back-end system will make use of this information in order to spot potential unwanted objects in an area.

In a possible embodiment traffic information, such as google traffic, and/or car information can be used to activate the object detection system in certain area. As an example, the system can receive information of cars slowing down, cars taking an unusual turn, cars rerouting, etc. This can be an indication that something has happened in that particular area.

Also type of object can be determined by determining the characteristics of the object:

Light is being emitted on the object, the camera is capable of capturing the reflected light coming back from the object. The type of object can be determined by determining the size in combination with the reflection. In case a lot of light is being reflected back it is probably a shiny material (metal or glass), fluid (rain puddle) etc. While if not much light is reflected back it can be a rubber or natural material such as a tree.

When an unwanted object, e.g. object A, is detected by the system at a certain location, the exact coordinates and other characteristics (size and shape by analysing the shadow) of the object A are stored in the back-end system. In case another unwanted object, e.g. object B, is detected, the system will automatically check if the characteristics (location, size, shape, etc.) of the objects detection earlier. In case object A is not detected anymore but in the same area (e.g. 50 meter) object B is detected with similar characteristics (size, shape, reflection). The system knows that the object A might be similar to object B, meaning that the object has moved, (e.g. due to wind, water, or it is being hit by something). Within this information the system is capable of determining the weight and possibly the material of the unwanted object.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A global object detection system comprising a plurality of local object detection systems, each arranged to monitor a respective area and comprising:
at least one image capture device arranged to capture image data from its respective area;
at least one illumination device for emitting light into its respective area;
a local object detector connected to the image capture and illumination devices for detecting objects in that area;
a data interface for transmitting data from the local object detector to a central, remote image processing system via a communication channel between the local object detector and the remote image processing system;
wherein the local object detector is configured to:
control the illumination source to emit light having an identifiable characteristic whilst the image data is captured;
apply local image processing to the captured image data to detect objects when present in that area, a present object detected from an absence of the identifiable characteristic in a shadow region created by the object;
in response to an object being detected, transmit a portion of the image data including the detected object via the communication channel to the remote image processing system for further processing.

2. The global object detection system of claim 1, wherein the portion of image data is transmitted to the remote image processing system in response to the local object detector determining that the detected object meets a set of one or more object criteria.

3. The global object detection system according to claim 2, wherein the local object detector is further configured to determine an estimated size of the object based on a size of the shadow region, and wherein said transmission of the portion of the image data is performed in response to determining that the estimated size is larger than a threshold size.

4. The global object detection system according to claim 2, wherein the local object detector is further configured to determine a reflection property of the object from the image data, and wherein said transmission of the portion of the image data is performed only if the reflection property corresponds to one of a predetermined set of materials.

5. The global object detection system according to claim 2, wherein the local object detector is further configured to determine an estimated location of the object based on a location of the shadow region, and wherein said transmission of the portion of the image data is performed in response to determining that the estimated location is within a predetermined sub-region of the area.

6. The global object detection system according to claim 1, wherein the portion of image data is transmitted to the remote image processing system in response to the local object detector determining that area meets a set of one or more area criteria.

7. The global object detection system according to claim 6, wherein the local object detector is further configured to receive traffic information indicating an amount of traffic within the area; and wherein said controlling the illumination source to emit light having an identifiable characteristic is performed in response to said amount of traffic exceeding a threshold amount of traffic.

8. The global object detection system according to claim 1, wherein the local object detector is further configured to determine a characteristic of ambient light within the area; and wherein said identifiable characteristic is chosen by the local object identified to be different from the determined characteristic of the ambient light.

9. The global object detection system according to claim 1, wherein the local object detector is further configured to control a visible characteristic of the light emitted by the illumination source which allows a user to distinguish the emitted light by said illumination source from light emitted by other illumination sources and thereby also identify the illumination source.

10. The global object detection system according to claim 9, wherein the property of the emitted light is one or more of: a colour; and a flashing rate.

11. The global object detection system according to claim 9, wherein the property of the emitted light is an identifier code emitted as high-frequency modulations in the emitted light.

12. The global object detection system according to claim 1, wherein the local object detector is further configured to store properties of a first detected object to a memory; upon detection of a second detected object at a later point in time, to access the memory to determine whether or not the detected second object has the same properties as the properties of the first object stored in memory; and, if so, to include in a second transmission to the remote image processing system an indication that the second object matches the first object.

13. A local object detector arranged for use in the global object detection system according to claim 1.

14. A method of detecting objects in a global object detection system comprising a plurality of local object detection systems, the method comprising steps of:
capturing image data from a respective area monitored by the local object detection system using at least one image capture device;
control at least one illumination source to emit light into the area having an identifiable characteristic whilst the image data is captured;
apply local image processing to the captured image data to detect objects when present in that area, a present object detected from an absence of the identifiable characteristic in a shadow region created by the object;
in response to an object being detected, transmit a portion of the image data including the detected object via a communication channel to a remote image processing system for further processing.

15. A computer program product comprising computer-executable code embodied on a computer-readable storage medium configured, so as when executed by one or more processing units, to perform the steps according to method claim 14.
